(19) United States
(12) Patent Application Publication
(10) Pub. No.: US 2015/0089975 A1
(43) Pub. Date: Apr. 2, 2015

(54) INDICIA-BEARING OBJECTS FOR MOUNTING AND DISPLAYING ON CORDS

(71) Applicant: Cord Concepts LLC, Seattle, WA (US)

(72) Inventors: David A. PALESCHUCK, Seattle, WA (US); Maurice PALESCHUCK, Great Neck, NY (US)

(73) Assignee: Cord Concepts LLC, Seattle, WA (US)

(21) Appl. No.: 14/502,467

(22) Filed: Sep. 30, 2014

Related U.S. Application Data
(60) Provisional application No. 61/885,451, filed on Oct. 1, 2013.

(51) Int. Cl. G09F 23/00

(52) U.S. Cl. CPC G09F 23/00
USPC 63/1.13

(57) ABSTRACT

Indicia-bearing objects for mounting, identifying and displaying on cords, strings, cables, laces, etc. are provided. The objects may ornamental and/or identifying objects configured for mounting and displaying on electrical and/or electronics cords, including cords for consumer electronics such as ear-bud cords and phone cords, as well as on lanyards, draw strings, pull strings, shoe laces, necklaces, bracelets, and the like. Several alternative constructions are disclosed in detail. The objects may additionally incorporate visual features in the form of an LED light (for example), and/or audio features via a prerecorded audio message, sound, musical composition (or the like).

### REFERENCE TO RELATED APPLICATION

This application claims priority to U.S. Provisional Patent Application No. 61/885,451, filed Oct. 1, 2013. The priority application is incorporated by reference in this application in its entirety.

### FIELD

The present disclosure relates to indicia-bearing objects for mounting and displaying on cords, strings, cables, lanyards, draw strings, pull strings, laces, necklaces, bracelets, and the like. In one aspect, the indicia-bearing objects are ornamental and/or identifying objects configured for mounting and displaying on electrical and/or electronics cords.

### BACKGROUND

Accessories for mounting on cords for displaying an ornamental message or design, or for displaying an advertising message, are known. U. S. Patent Publications 2012/0151809 and 2013/0263483 and PCT Int'l Publication WO 2012/087396 disclose a system for creating and displaying an advertising message on a cord or string, such as a head phone cord or pull string for clothing. The system involves two piece constructions in which an internal gripping sleeve attaches to the cord or string and is retained in a bore in a larger fixture that bears a message, design or the like.

Other systems for labeling electrical cords and conductors, pipes, conduits, tubes and rods, and flexible tubing are described in U.S. Pat. Nos. 5,170,578, 7,194,829, 7,856,745 and 8,516,727.

### SUMMARY

Indicia-bearing objects as disclosed herein may display ornamental or identifying information, graphics, colors, configurations or the like, and may have various three-dimensional configurations. The objects may be provided in various sizes and shapes, with continuous or discontinuous external walls. Each indicia-bearing object is configured for mounting on a cord, string, cable, lanyard, lace, chain or the like (referred to herein, collectively and generally, as “cord(s)”); several exemplary alternative configurations for fabricating indicia-bearing objects that mount to cords are disclosed. In some embodiments, the indicia-bearing objects are specifically configured and constructed for mounting to cords of the type used with ear buds for electronic devices and for other types of cords that interface with electronic devices.

Visual and/or audio components may be incorporated in or associated with indicia-bearing objects, as disclosed herein. A visual component may be incorporated, for example, in the form of an LED light actuatable in response to a user's input and/or in response to environmental conditions, such as motion. An audio component may be incorporated, for example, in the form of an audio chip that, likewise, may be activated by the use or in response to environmental conditions such as motion, a change in lighting, temperature, or the like. These and additional embodiments and features are described in greater detail below.

### BRIEF DESCRIPTION OF THE FIGURES

FIG. 1 shows a perspective view of three alpha-numeric indicia-bearing objects mounted on a cord.

FIG. 2 shows an upper, front perspective drawing illustrating one embodiment of an indicia-bearing object as disclosed herein having a slot penetrating one side of the object and terminating in a larger through-bore for receiving a cord.

FIG. 3 shows an upper, rear perspective view illustrating the indicia-bearing object as shown in FIG. 2 from the rear.

FIG. 4 shows a perspective view of an alternative object construction in which a tapered inner plug has a cord-receiving bore and mates with a mating tapered channel provided in the object, which has a three-dimensional character profile.

FIG. 5 shows a perspective view of an object having two-member, snap-together construction in which a through-bore for receiving a cord is formed when the complementary members are joined, and the external configuration of the object is a three-dimensional character profile.

FIG. 6 shows a perspective view of an object having a clam-shell type of construction in which two complementary members are joined at a hinged portion and the members are closeable to form an indicia-bearing object having a through-bore for receiving a cord. The external configuration of the object is in the form of a soccer ball.

FIG. 7 illustrates a rear perspective view of an object having a face displaying alpha-numeric indicia and having a “gated” channel construction, in which channels for receiving a cord and mounting the object on a cord are provided in association with the object.

FIG. 8 illustrates a rear perspective view of another object having a face displaying indicia and having an alternative type of channel construction, in which channels for receiving a cord or the like are formed on one face of the object.

FIG. 9 illustrates a perspective view of an alternative construction of an indicia-bearing object in which two complementary members may be joined by inserting a prong of one member into a mating recess of the other member to provide a unitary object havng a through-bore for receiving a cord.

FIG. 10 schematically illustrates visual and audio enhancements providing illumination and/or audio features incorporated in indicia-bearing objects as described herein.

FIG. 11 schematically illustrates an indicia-bearing object having audio and/or illumination feature(s) (represented by the audio projection symbol).

FIG. 12 schematically illustrates a plurality of indicia-bearing objects, each displaying different indicia and providing different audio features, as indicated, mounted on a cord.

FIG. 13 illustrates exemplary indicia-bearing objects mounted on a pull string of a backpack.

FIG. 14 illustrates exemplary indicia-bearing objects mounted on drawstrings of a sweatshirt.

FIG. 15 illustrates a plurality of alpha-numeric indicia-bearing objects mounted on an ear-bud cord.

FIG. 16 illustrates a single object bearing multiple alpha-numeric indicia mounted on an ear-bud cord.

FIG. 17 illustrates multiple indicia-bearing objects mounted on ear-bud cords.

### DESCRIPTION

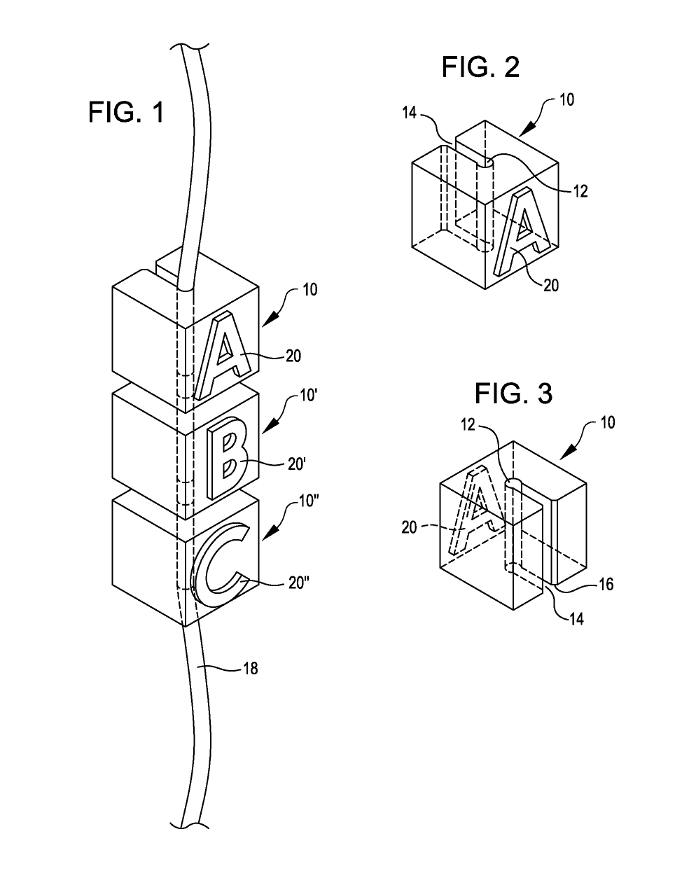

FIGS. 2 and 3 illustrate one embodiment of an indicia-bearing object as disclosed herein, and FIG. 1 illustrates a plurality of such indicia-bearing objects mounted on a cord. In the embodiment illustrated in FIGS. 2 and 3, three-dimensional objects 10 have an external configuration in the form of a cube. In alternative embodiments, three-dimensional objects having a variety of external configurations may be provided, including objects having different three-dimensional geometrical shapes including, without limitation, spheres, polygons, ball configurations (e.g., basketballs, soccer balls, baseballs, and the like), other sporting goods configurations (e.g., hockey pucks, footballs, rugby balls, and the like), three dimensional character configurations (e.g., cartoon characters, animated movie characters, sports, entertainment and popular culture figures, logo configurations, and the like), and other three-dimensional configurations representing animals, objects, and the like. The three dimensional objects may be provided in a wide variety of sizes as well as three dimensional shapes. In some embodiments, the largest cross-sectional dimension of the three-dimensional object (e.g., width, length or depth) may be from about 0.25 to about 5 inches; in some embodiments, the largest cross-sectional dimension of the three-dimensional object may be from about 0.4 to about 2 inches; in yet other embodiments, the largest cross-sectional dimension of the three-dimensional object may be from about 0.5 to one inch. In some embodiments of three-dimensional objects having multiple geometrical faces, such as the cubic objects shown in FIGS. 1-3, each face may range from about 0.25 to about 1.0 inch square.

In the embodiment illustrated in FIGS. 1-3, a through-bore 12 penetrates the object along an axis, and a slot 14 provides a passageway from an external location to through-bore 12 and terminates at through-bore 12. Through-bore 12 is generally dimensioned and configured to accommodate and permit passage of the full dimensions of one or more cords. Through-bore 12 may have a generally cylindrical configuration, as illustrated, or it may have a different curved (e.g., oblong, oval, corrugated or the like) or polygonal (e.g., square, triangular, or the like) configuration. In some embodiments, through-bore 12 is sized and configured to provide frictional contact with a desired cord when the desired cord is positioned in the through-bore. The frictional contact is preferably sufficient to permit user manipulation and active sliding of the object on the cord during user positioning of the object, while prohibiting substantial sliding of the object on the cord without user manipulation.

In some embodiments, through-bore 12 has a substantially constant largest cross-sectional dimension along its length; in alternative embodiments, through-bore 12 may be tapered or have variable cross-sectional dimensions along its length. The largest through-bore cross-sectional dimension referred to in this context is the largest dimension of a cross-section taken generally orthogonal to the length of the through-bore. The largest cross-sectional dimension of a cylindrical bore is the diameter of the cross-sectional circular configuration of the cylindrical bore; the largest cross-sectional dimension of a polygonal bore is the largest dimension extending from one point on a polygonal cross-section taken generally orthogonal to the length of the bore to another point.

In embodiments in which through-bore 12 has a substantially constant largest cross-sectional dimension along its length, its largest cross-sectional dimension is the same as or slightly larger than a largest cross-sectional dimension (i.e., a cross-sectional dimension taken generally orthogonal to the length of the cord) of the cord. By “slightly larger than,” we mean no more than 1% or no more than 3% or no more than 5% or no more than 10% or no more than 20% larger than the largest cross-sectional dimension of the cord. This sizing permits a cord to be received, retained in and stably mounted through the through-bore and permits active sliding of the object on the cord for user positioning of the object, while prohibiting substantial sliding of the object on the cord without user manipulation.

In many embodiments, the surface of through-bore 12 is smooth; in some embodiments, the surface of through-bore 12 may be rough or have surface discontinuities or raised portions or textured or gripping projections that tend to grip and prohibit substantial sliding of the object on a cord traversing the bore without user manipulation. In some embodiments, surfaces of through-bore 12 may comprise or be fabricated, at least in part, from a material having generally softer or stickier or grippier properties than material(s) forming other portions of the object. This feature provides a through-bore that tends to promote gripping of a transiting cord and prohibit substantial sliding of the object on the cord without user manipulation.

Through-bore 12 is illustrated penetrating object 10 along a generally central axis, and this arrangement is suitable for many embodiments. Through-bore 12 may alternatively penetrate object 10 along an axis off-set from center, along an axis angled with respect to a central axis, or along other axes. In many embodiments, through-bore 12 penetrates the object along an axis extending generally orthogonal to the plane of the end face(s) it penetrates, as shown in FIGS. 1-3.

In many embodiments, a slot penetrates the object along one sidewall or surface, as shown in FIGS. 1-3. Slot 14 penetrates at least one exterior wall of object 10 and is generally dimensioned and configured to accommodate passage of a cord oriented along its narrowest dimension. The slot may be arranged to form a keyhole like configuration in combination with the through-bore, as shown in FIGS. 1-3, and may be located generally at a midline of the sidewall(s) it penetrates. In alternative embodiments, the slot may be oriented at an angle to and/or located to one or the other side of a midline of an object sidewall(s). In the embodiment illustrated in FIGS. 1-3, slot 14 is formed by generally opposed planar sidewalls oriented parallel to one another and terminating in through-bore 12. In alternative embodiments, slot 14 may be formed by sidewalls having planar surfaces oriented other than parallel to one another, or the slot may comprise curved, and/or contoured sidewalls.

Slot 14 may have a generally constant width along its length, as shown. Alternatively, slot 14 may have a variable width along its length and may be tapered, for example, with a wider portion in proximity to an external wall of the object and a narrower portion in proximity to through-bore 12. Like the surface of the through-bore, the surfaces forming slot 14 may be smooth or may, alternatively, may be rough or have surface discontinuities or raised portions or textured or gripping projections that tend to grip a cord or string traversing the slot. In some embodiments, the area in proximity to the interface of each slot wall with the nearby surface of the object wall may be chamfered or curved as illustrated by chamfer 16 to provide a smooth transition between the slot and the outer object surface, facilitating insertion of a cord into the slot.

In some embodiments, the width of slot 14 is less than the diameter of through-bore 12, as shown. In some embodiments, the width of slot 14 measures about 60% to 80% the diameter of through-bore 12; in some embodiments, the width of slot 15 measures about 75% the diameter of through-bore 12. In some embodiments, the width of slot 14 is between about 0.05 and 0.07 inch and the diameter of through-bore 12 is between about 0.07 and 0.09 inch. In some embodiments, the width of slot 14 is about 0.06 inch and the diameter of through-bore 12 is about 0.08 inch. In some embodiments, the slot and through-bore combination are configured for passage of cords terminating in standardized 3.5 mm or 6.35 mm headphone jacks.

Indicia (whether identifying, ornamental, or the like) may be provided on one or more faces of an object, and may be formed as part of, printed on, applied to, attached (by adhesives, fasteners, etc.) to the underlying object, or the like. Indicia in the form of decorative or identifying matter may be inset with respect to an exterior surface of the object, or the indicia may be substantially coextensive (e.g., level) with an exterior surface of the object, or the indicia may be raised with respect to an exterior surface of the object, or a combination of these. In the embodiments illustrated in FIGS. 1-3, alphanumeric indicia 20 in the form of Latin letters are displayed on one face of each object. The indicia (e.g., alpha-numeric characters “A”, “B”, “C” in FIGS. 1-3) may be formed as part of, applied to or mounted on the object and raised (or depressed) at a level ranging, for example, from about 1/32 inch to about ¼ inch from the surface of one (or more) object face(s). Although Latin alpha-numeric indicia are illustrated in FIGS. 1-3, It will be appreciated that different indicia, such as indicia originating with other alphabet and numbering systems, words, acronyms, slang, character strings, logos, ornamentation, and the like, may be used in connection with indicia-bearing objects as described herein. It will also be appreciated that while the alpha-numeric indicia illustrated in FIGS. 1-3 are displayed on a single face of the object, the same or different indicia may be displayed on multiple object faces, surfaces, or the like.

FIG. 1 shows multiple objects 10, 10′, 10″ bearing alphanumeric indicia 20, 20′, 20″ mounted on cord 18. Each object is typically mounted on (and removable from) the cord individually, and individual objects may be selectively mounted on, removed from and repositioned on the cord independently of one another. The slot and through-bore configuration illustrated in FIGS. 1-3 permits convenient mounting of objects as and where desired on the cord, without requiring manipulation of the cord or removal of the cord from an associated device. The configuration and construction of the slot and through-bore elements of the objects also provides secure positioning of objects on a cord, desirably preventing undesired sliding or re-positioning of objects on the cord once they've been positioned by the user.

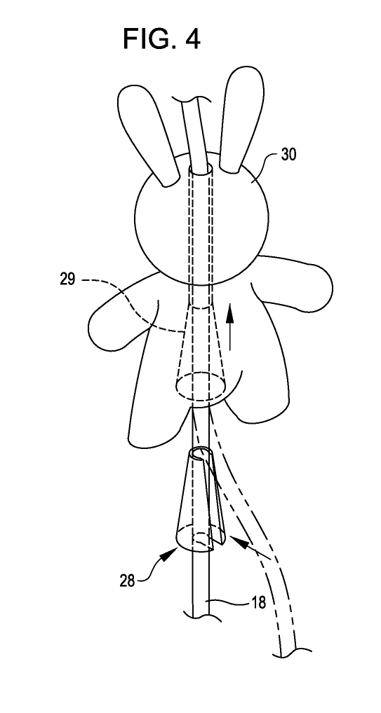

Alternative configurations and constructions for indicia-bearing objects are illustrated in FIGS. 4-9. FIG. 4 shows an embodiment in which the object comprises an inner plug and an external component Inner plug 28 has a slot and through-bore arrangement for receiving a cord and has a keyed external configuration that is received in a complementary, matingly-shaped and sized recess 29 in external component 30. In the embodiment illustrated in FIG. 4, inner plug 28 has a tapered conical configuration with a larger dimension “lower” area and a smaller dimension “upper” section, as shown. In this embodiment, a cord 18 is positioned in the through-bore of inner plug 28 after transiting the slot, and inner plug 28, with cord 18 retained in its through-bore, is then mounted in mating recess 29 of external component 30, so that cord 18 traverses the external component 30 and inner plug 28 is securely retained in the external component 30. As the tapered conical (or otherwise keyed) inner plug is inserted into the matingly-shaped recess in the external component, frictional forces firmly anchor the matingly shaped plug and recess surfaces against one another, thereby anchoring the inner plug within the external component, and thereby anchoring the object on the cord.

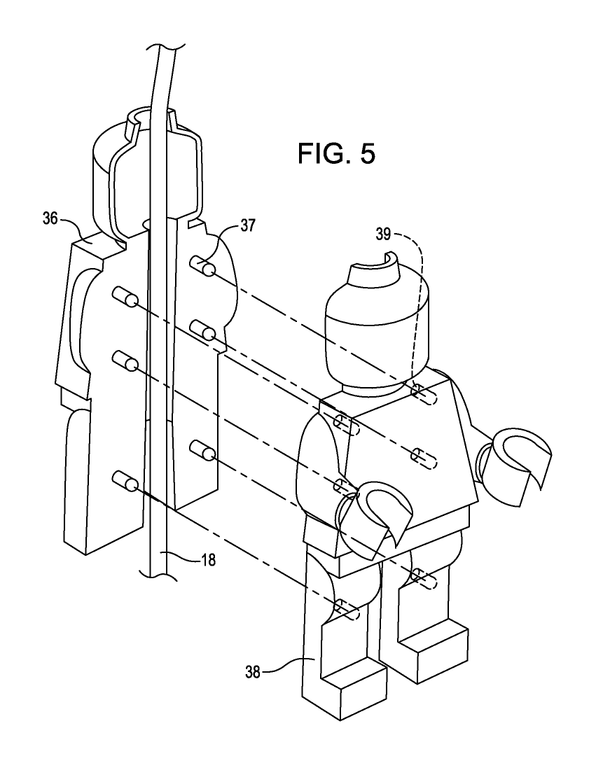

FIG. 5 schematically illustrates another embodiment in which the object, shown as a three-dimensional character form, is formed when two complementary members are mounted or attached to one another and a through-bore is provided penetrating the assembled complementary members. In this embodiment, each complementary member 36, 38 has at least one connector element (such as a pin/receiving hole, male/female snaps, mating fasteners, etc.) that mates with another connector element provided on the complementary member to join the members and form a unitary object. In the embodiment illustrated in FIG. 5, the object is composed of complementary members 36 and 38 that, when mounted to one another, form an object having a three-dimensional character configuration. Member 36 has a plurality of pins 37 projecting from an interior surface, while member 38 has a plurality of complementary recesses 39 sized and arranged to receive pins 37.

Additionally, in the embodiment illustrated in FIG. 5, each of the complementary members 36, 38 has a complementary curved (e.g., semi-cylindrical) recess that provides a portion of the through-bore for securing the object on a cord when the two complementary members are mounted to one another. This arrangement permits the complementary members to be positioned on opposite sides of and mounted over the cord, then fastened together to complete the three-dimensional external configuration of the object and securely mount it on a cord. In alternative embodiments, a through-bore for receiving the cord may be located substantially or entirely in one or the other complementary member and accessed via a slot or the like, as previously described.

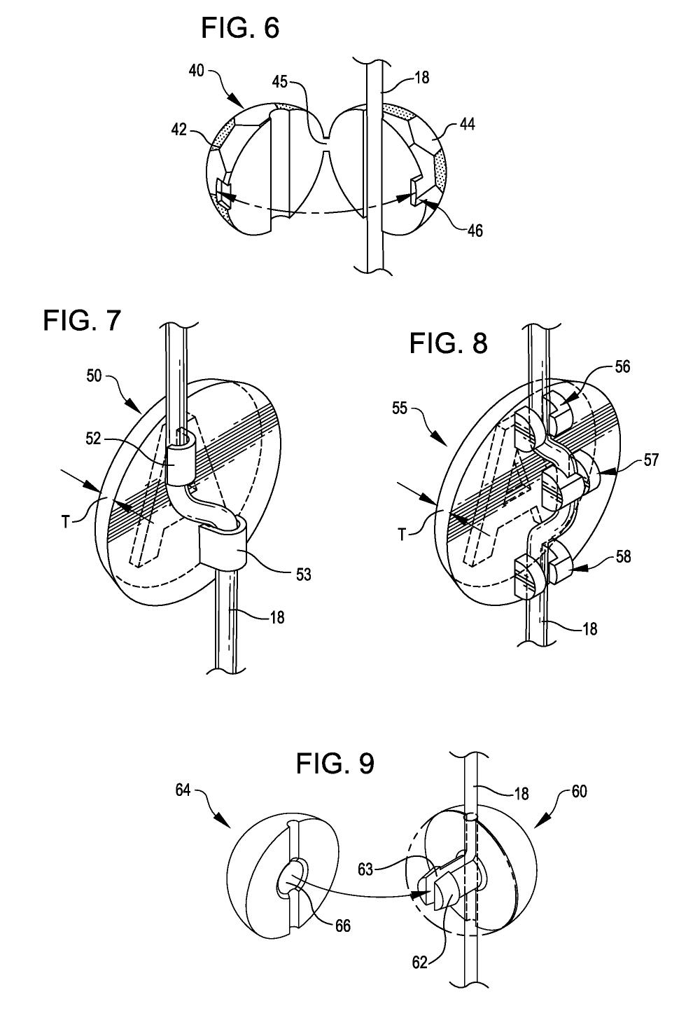

FIG. 6 shows another alternative embodiment in which object 40 comprises two complementary members having a hinged, clamshell-like arrangement and construction. In this embodiment, object 40 comprises two complementary members 42, 44, a hinge 45 provided at or along one interface of complementary members 42, 44, and an optional closure mechanism 46 provided at or along an opposite interface of complementary members 42, 44. Additionally, in the embodiment illustrated in FIG. 6, each of the complementary members has a curved (e.g., semi-cylindrical) recess that, in combination with the complementary recess of the complementary member, provides a through-bore for securing object 40 on a cord when complementary members 42, 44 are in a closed condition. In operation, complementary members 42, 44 are placed on opposite sides of and mounted over a cord, as shown, then fastened together to form the object and mount it on the cord. In alternative embodiments, the through-bore for receiving the cord may be located substantially or entirely in one or the other complementary member and accessed via a slot or the like, as previously described.

Hinge 45 may be provided as a rigid, semi-rigid or flexible connector between and integrated with complementary members of the object, as illustrated in FIG. 6, and may be provided along substantially the entire length of a connection interface of the complementary members. Alternatively, hinge 45 may be provided along only a portion of the length of an interface between complementary members, and the hinge may be continuous or discontinuous along the length of an interface. Many different type of hinge constructions are known and may be used in connection with objects as described herein. In some embodiments, a hinge is provided as a thinner or weaker section of material providing flexing or pivoting of adjacent members with respect to one another. Optional closure mechanism 46 for securing complementary members in a closed condition may be provided as a male/female snap combination, an interlocking snap closure, mating fasteners, friction engagement mechanisms, a clasp mechanism, a tab and receiving recess or projection, or the like. Many suitable closure mechanisms are known and would be suitable for this application.

In the embodiments illustrated in FIGS. 5 and 6, each of the complementary members is substantially similarly sized, and each has substantially the same external configuration. It will be apparent that other arrangements using a mating pin and receptacle, snap-fit, or clamshell-like construction may be provided, including embodiments in which the constituent and complementary members are not similarly sized or configured.

FIGS. 7 and 8 illustrate yet additional alternative embodiments in which flexible gates overlie or form a channel for retaining a cord. In these embodiments, the cord is routed through or around or behind flexible gates or channels to mount the object on a cord, and the object is retained on the cord by means of frictional contact of the gates or channels with the cord. FIG. 7 illustrates an embodiment in which at least two gates 52, 53 are provided on a surface of object 50, each of the gates 52, 53 being sized and configured for receiving and retaining a desired cord. Gates 52, 53 for receiving a cord(s) may be positioned along a generally linear path, or they may be positioned along an offset or serpentine or non-linear path, as shown in FIG. 7. The geometry of the path, as well as the configuration of the cord-receiving gates, creates frictional contact with the cord received through the gates, allowing firm positioning of object 50 on cord 18, as shown. Gates 52, 53 may have substantially the same size and configuration, or they may have different sized and configurations.

In the embodiment illustrated in FIG. 8, a non-linear or serpentine channel is formed by a series of opposing gates 56, 57, 58 positioned on or associated with one face of object 55. Gates 56, 57, 58 may be provided as complementary opposing components, in combination forming an access slot and an internal channel, as shown. Gates 56, 57 58, are sized, configured and positioned for stably retaining a desired cord in the channel formed between each set of opposing components, and at least two sets of opposing components are positioned along an offset or serpentine or non-linear path, as shown in FIG. 8. Cord 18 may be routed through channels formed by the gates to securely mount object 55 on cord 18, as shown.

Objects 50, 55 shown in FIGS. 7 and 8 illustrate embodiments in which the objects have a three dimensional configuration but are relatively “flat,” with a primary face (opposite the cord channel) bearing indicia (shown as alphanumeric “A” in FIGS. 7 and 8). The overall thickness of the objects, measured as the dimension taken from an indicia-bearing surface to a cord interface surface, may be less than a largest dimension of the indicia-bearing face of the objects. In some embodiments, the overall thickness of the objects, shown as T in FIGS. 7 and 8, may be less than 60% or less than 50% or less than 35% of the largest dimension of the indicia-bearing face of the objects.

FIG. 9 schematically illustrates yet another embodiment in which complementary members interface with and mount to one another to provide an indicia-bearing object having a through-bore for receiving a cord. In this embodiment, first member 60 has an external surface suitable for displaying indicia and a prong 62 with a cord-receiving channel 63. Second member 64 has an external surface suitable for displaying indicia and a cavity 66 sized and configured for receiving and securely retaining prong 62. One or both of the members may have a curved recess providing a through-bore for securing the object on a cord when complementary members 60, 64 are mounted to one another. In operation, a cord is mounted on member 60 by insertion through cord-receiving channel 63 of prong 62, and prong 62 is then inserted into the mating cavity 66 in member 64 and advanced until the cord is snugly gripped in a through-bore penetrating the members.

Several exemplary configurations for providing indicia-bearing objects that conveniently and securely mount on cables have been described. Those having skill in the art will appreciate that many additional and alternative configurations for providing such indicia-bearing objects may be implemented without departing from the spirit of the disclosure provided herein.

One or more faces of an object as described herein may bear indicia, such as identifying indicia, ornamental indicia, or the like. In some embodiments, the indicia are simply colors, decorations, or the three-dimensional outer configuration of the object itself. In some embodiments, the indicia are visually distinct from the object(s), and may be part of, embedded in, printed on or otherwise applied to or associated with one or more faces of the object(s). In some embodiments, the indicia are substantially flat vis a vis the face of an object and do not form a substantially raised surface. In some embodiments, the indicia are raised, as shown in FIGS. 1-3. Indicia may include alphanumeric letters and/or numbers (using different alphanumeric systems), symbols, words, ornamentation, colors, icons, logos, designs, team names, indications of other affiliations, and the like.

While indicia-bearing objects having different three dimensional external configurations are illustrated in FIGS. 1-9, it will be appreciated that objects having other outer contours and shapes, including round and other curved shapes, other polygonal shapes, and a variety of other 3-dimensional shapes may be used. Three-dimensional object configurations may include, without limitation, three-dimensional characters (e.g., animals, cartoon characters, comic or hero characters, sports figures, music, entertainment, popular culture and arts figures, or the like), fruit and vegetable shapes, athletic equipment and sports-related shapes (e.g., basketballs, footballs, soccer balls, hockey pucks, or the like), toy shapes, logos, symbols, and the like. In some embodiments, color or surface contour alone may constitute the indicia. When the object is provided as a three-dimensional contoured shape for example, the three-dimensional configuration itself, color and/or decoration associated with the object may serve as the identifying and/or ornamental indicia.

In some embodiments, the objects may be rigid or semi-rigid; in alternative embodiments the objects may be soft and/or pliable. In some embodiments, the objects may be constructed, at least in part, from polymers, thermoplastic and plastic materials, natural materials, and the like. Materials such as Polypropylenes (PP), Polyethylenes, Polystyrenes, Acrylanitrile Butadiene Styrene (ABS), Polycarbonates (PC), Polycarbonate/ABS alloys, Acetal polymers, Acrylics, amorphous polymers such as Poly(methyl methacrylate) (PMMA), Nylons (e.g., Nylon 6, Nylon 6-6, Nylon 11 and the like), Polysulphones, Polyaryletherketone (PAEK) polymers, such as polyether ether ketone (PEEK), Polyesters, such as Polybutylene Terepthalate (PBT), Polyester Liquid Crystal Polymer (LCP), Polyimides in both amorphous and crystalline forms, Polyphenylene Oxides (PO), polyphenyl polyethers (PPE), including compositions in the NORYL™ family of modified PPE resins comprising amorphous blends of PPO polyphenylene ether (PPE) resin and polystyrene, Polyphenylene Sulfides (PPS), Polysulfones, members of the ULTEM family of amorphous thermoplastic polyetherimide (PEI) resins, and other high performance, engineered resins may be used, as well as high and/or medium density foams, silicones and silicone-containing materials (including but not limited to Liquid Silicone Rubber (LSR)), rubbers and rubber-containing materials, and the like. Suitable durometers of these materials, and the objects disclosed here, may range from hard to soft.

In some embodiments, objects as described herein may be constructed from multiple materials having different properties. In one embodiment, for example, external walls of objects may be constructed from one or more materials having higher rigidity (and higher durometer) properties, while indicia such as decorative or identifying elements may be constructed from one or more materials having lower (relative) rigidity (and lower durometer) properties. In one specific embodiment, an object may be fabricated from a generally rigid polymeric material, while indicia are fabricated from a softer material, such as Liquid Silicone Rubber. In another specific embodiment, one complementary member forming an object may be fabricated, entirely or in part, from a generally rigid polymeric material, while a mating complementary member may be fabricated, entirely or in part, from a softer material, such as Liquid Silicone Rubber. In some embodiments, different portions of objects (such as through-bores and/or slots) may be fabricated, entirely or in part, from materials having different properties from materials used for constructing other portions of the objects.

Indicia-bearing objects as described herein may have additional features. They may, for example, have additional visual features such as illumination or “glow” features. In some embodiments, objects, or portions of objects, may incorporate LED components and/or phosphorescent materials that glow in the dark. In some embodiments, objects may incorporate audio features, such as audio chips, providing audio play of messages, sounds, songs, music and other recorded and/or recordable sounds.

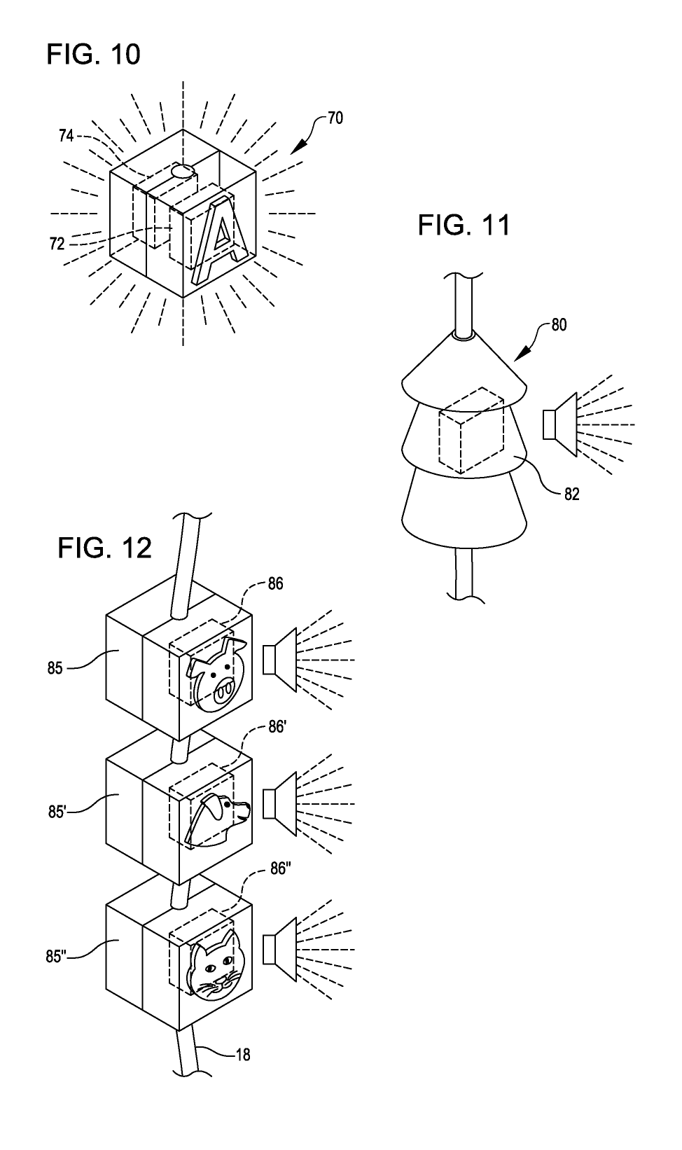

FIG. 10, for example, schematically illustrates an object 70 having a cord through-bore and bearing an alphanumeric indicia. Object 70 additionally comprises a visual component 72 comprising, for example, an LED and an audio component 74 comprising, for example, an audio chip, both positioned within an internal volume of object 70. FIG. 11 illustrates an object 80 displaying a three-dimensional configuration representing a tree (e.g., a Christmas tree) and having an audio component 82 provided in an internal volume. Audio component 82 may be activatable by a user to play a holiday message or a Christmas carol, for example. FIG. 12 schematically illustrates a plurality of objects 85, 85′, 85″ mounted on a cord, each of the objects incorporating an audio component 86, 86′, 86″. In the exemplary embodiment of FIG. 12, each of the objects displays indicia identifying the sound made when the audio component is activated. In some embodiments, an audio chip may incorporate a pre-recorded audio message, sound, musical composition, performance or the like. Audio chips bearing custom recorded messages may also be insertable into or associated with objects as disclosed herein.

Visual components may be incorporated in objects as described herein in the form of an LED source or a plurality if LED sources, for example, that may be activated to illuminate the object from either outside or inside the object. Other types of visual components providing illumination features may also be provided in association with objects as described herein. Audio components may comprise electronic chips that, when activated, play an audio message or make a sound or play a musical composition, or the like. In some embodiments, a visual (and/or audio) component may be activated by a user (e.g., by activating a switch), while in other embodiments a visual (and/or audio) component may be activated upon sensing an internal or external condition, such as temperature, light condition, moisture, or the like. In some embodiments, a visual (and/or audio) component may be activated as a consequence of movement or motion of the components and/or the associated objects . In some embodiments, indicia or a portion of an external object wall in proximity to a visual (and/or audio) component may comprise a pliable material that is depressable, or squeezable, to facilitate user activation of an underlying switch for activating a visual (and/or audio) component. The visual and/or audio components are preferably self-powered. Rechargeable and/or replaceable batteries may be provided as power sources for visual and/or audio components.

Visual and/or audio components may be associated with objects as described herein in many ways. They may, for example, be molded directly into an object during an injection molding process or using another fabrication technique. Alternatively, visual and/or audio components may be housed within an object in a recess or another location in the interior volume of the object without interfering with cord passage through the object. One having skill in the art will appreciate that many different strategies for providing visual and/or audio features in objects such as those described herein are available.

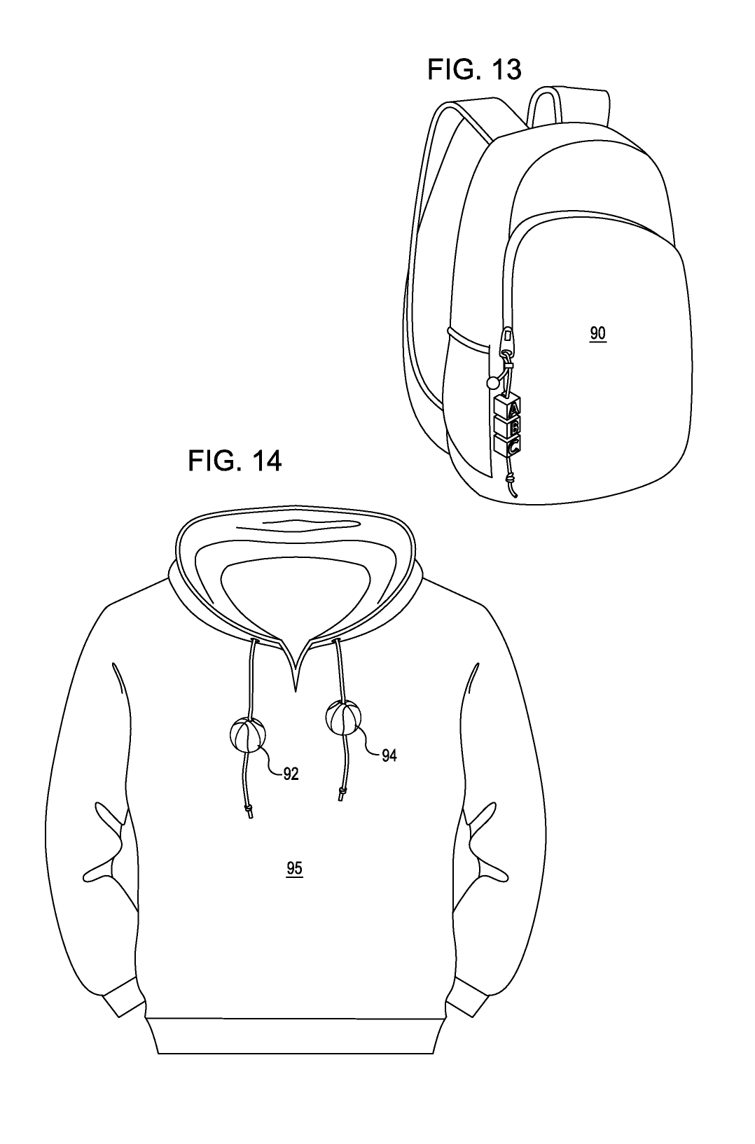

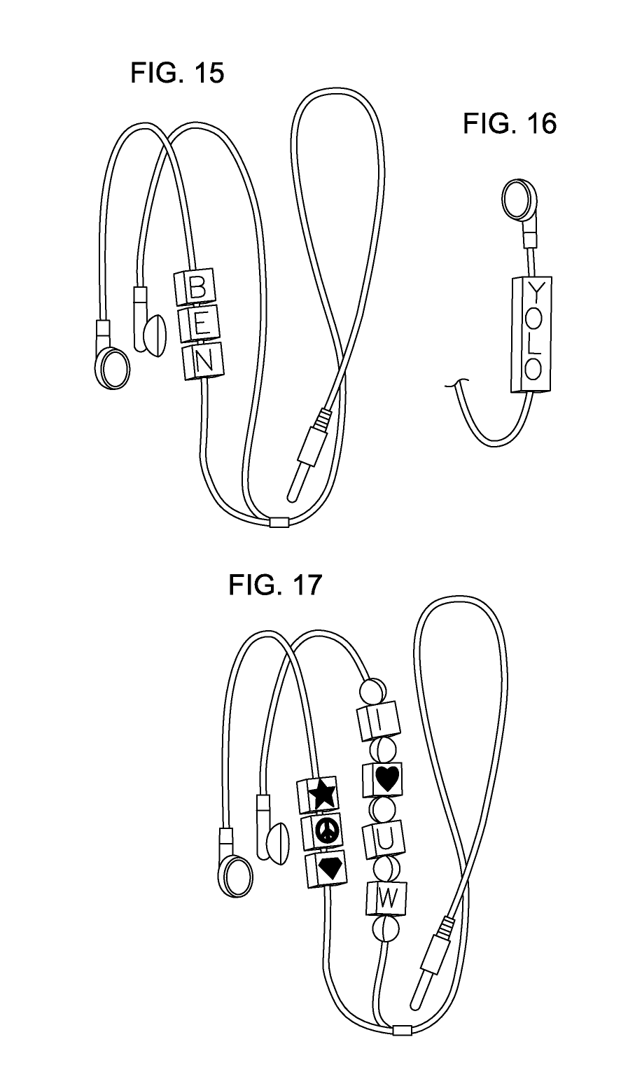

FIGS. 13 and 14 illustrate, schematically, various applications for objects described herein. FIG. 13 schematically illustrates a plurality of indicia-bearing objects (A, B, C) mounted on a pull cord provided on a backpack 90, and FIG. 14 schematically illustrates indicia-bearing objects 92, 94 having a basketball configuration mounted on drawstrings of a sweatshirt 95. FIGS. 15-17 illustrate exemplary indicia-bearing objects mounted on cords for consumer electronics. It will be appreciated that many additional applications are available, and that objects as described herein may be constructed and configured for display in connection with a wide variety of cords, laces, lanyards, fashion accessories, handles and the like.

In the description provided above, the term “about” means +/−20% of the indicated value or range unless otherwise indicated. The term “substantially” used with respect to values means within a range of +/−5% of the value indicated unless otherwise defined. The terms “a” and “an,” as used herein, refer to one or more of the enumerated components or items. The use of alternative language (e.g., “or”) will be understood to mean either one, both or any combination of the alternatives, unless otherwise expressly indicated. The terms “include” and “comprise” are used interchangeably and both of those terms, and variants thereof, are intended to be construed as being non-limiting.

It will be appreciated that the indicia-bearing objects and objects incorporating visual and/or audio features described herein may be embodied in a variety of different forms, and that the specific embodiments shown in the figures and described herein are presented with the understanding that the present disclosure is considered exemplary of the principles of the invention and is not intended to limit any claimed subject matter to the illustrations and description provided herein. The various features and embodiments described may be combined in different combinations to provide further embodiments. The features described in connection with one exemplary embodiment may be used and incorporated in connection with other features described in connection with other exemplary embodiments. The devices, systems, methods and compositions, as described, may omit some elements or features, add other elements or features, or combine the elements and features in a different arrangement than that specifically described.

We claim:

1. An object bearing an identifying and/or ornamental indicia configured for mounting on a cord, wherein: the object has a three dimensional external configuration and an internal bore penetrating the object and having a substantially constant cross-sectional dimension along its length; wherein the substantially constant cross-sectional dimension of the internal bore is the same as or slightly larger than a largest cross-sectional dimension of the cord; and wherein the internal bore is accessible from a location external to the object for insertion of the cord.

2. The object of claim 1, additionally comprising a slot penetrating at least one face of the object and providing access to the internal bore.

3. The object of claim 2, wherein the slot has a width that is smaller than a largest cross-sectional dimension of the internal bore.

4. The object of claim 1, wherein the internal bore has a cross-sectional configuration selected from the group consisting of: cylindrical, oblong, oval, corrugated, and polygonal.

5. The object of claim 1, wherein the internal bore has a surface property selected from the group consisting of: smooth, rough, surface discontinuities, surface texture, and gripping projections.

6. The object of claim 1, wherein the internal bore is fabricated form a material having softer or stickier properties than a material forming other portions of the object.

7. The object of claim 1, wherein the internal bore penetrates a central axis of the object.

8. The object of claim 1, wherein the internal bore penetrates an axis of the object that is off-set from a central axis.

9. The object of claim 1, wherein: the object comprises an inner plug and an external component; the internal bore is provided in the inner plug and is accessible by a slot in the inner plug; and the inner plug is snugly mountable in a matingly-shaped recess in the external component.

10. The object of claim 1, wherein the object comprises two complementary members that are attachable to one another and, in combination, provide the three dimensional external configuration and the internal bore, and wherein a first complementary member has at least a first connector portion that mates with at least a second connector portion provided on a second complementary member.

11. The object of claim 1, wherein the object comprises two complementary members that are hinged to one another and, in combination, provide the three dimensional external configuration and the internal bore.

12. The object of claim 1, wherein the object comprises two complementary members that, in combination, provide the three dimensional external configuration and the internal bore, and the two complementary members are substantially similar in size and external configuration.

13. The object of claim 1, wherein the object comprises two complementary members that, in combination, provide the three dimensional external configuration and the internal bore, and wherein a first complementary member has a prong with a cord receiving channel and a second complementary member has a cavity sized and configured for receiving the prong.

14. The object of claim 1, additionally comprising a visual component that, when activated, emits a visually perceptible signal.

15. The object of claim 1, additionally comprising an audio component that, when activated, emits an audible signal.

16. The object of claim 1, wherein the object has one or more identifying or ornamental indicia printed on, applied to or attached to the object, and wherein the identifying or ornamental indicia is selected from the group consisting of: letters, numbers, symbols, words, ornamentation, icons, names, logos, acronyms, designs, team names, affiliation indications and colors.

17. The object according of claim 1, wherein the three-dimensional external configuration of the object provides the identifying and/or ornamental indicia and wherein the three-dimensional external configuration is selected from the group consisting of: cubes, rectilinear shapes, polygonal shapes, round shapes, curved shapes, animal shapes, fruit or vegetable shapes, character shapes, logo shapes, sporting equipment shapes, symbol shapes, letters, numbers and character likenesses.

18. An object bearing an identifying and/or ornamental indicia configured for mounting on a cord, wherein: the object has a three dimensional external configuration, an internal bore penetrating the object, and a slot penetrating at least one face of the object and providing access to the internal bore; and wherein the slot has a width that is smaller than a largest cross-sectional dimension of the internal bore.

19. An object bearing an identifying and/or ornamental indicia configured for mounting on a cord, wherein: the object has a three dimensional external configuration, an internal bore penetrating the object, and a slot penetrating at least one face of the object and providing access to the internal bore; and wherein at least a portion of the internal bore or the slot is fabricated from a material having a different durometer from another material of the object.
